(19) United States
(12) Patent Application Publication
(10) Pub. No.: US 2003/0123811 A1
(43) Pub. Date: Jul. 3, 2003

(54) Connector receptacle

(76) Inventor: Gregory A. Lyon, Indianapolis, IN (US)

Correspondence Address: PEARNE & GORDON LLP, 526 SUPERIOR AVENUE EAST, SUITE 1200, CLEVELAND, OH, 44114-1484, US

(21) Appl. No.: 10/038,749

(22) Filed: Jan. 2, 2002

(51) Int. Cl. G02B 6/38

(52) U.S. Cl. 385/59

(57) ABSTRACT

A receptacle housing for insertion into an opening of a receiving member, the receptacle housing comprising a plurality of surfaces including a front, right side and a left side surface. The receptacle housing having a cavity in the front surface thereof for receiving a connector. The receptacle housing having a protrusion on each of the right and left side surfaces, each protrusion ending with an edge, the protrusion permits the receptacle housing to slide through the receiving member. A lip is located around the front side surface of the receptacle housing. The receptacle housing is secured into an opening in the receiving member by the interaction of the lip around the front side surface and the edge on the protrusion. In addition, the plurality of surfaces are made from a polymer based material and both the plurality of surfaces and the cavity in the front surface thereof for receiving a connector, may be coated with a conductive material such as chrome or copper-nickel to provide shielding from electromagnetic interference.

### BACKGROUND OF THE INVENTION

This invention relates generally to a connector receptacle and more particularly, to a connector receptacle constructed from a polymer-based material coated with a conductive material that is used for connecting fiber optic cables into a receiving member, such as an electrical cabinet. It is well known to those skilled in the art that problems can occur when fiber optic cables are connected into their appropriate location in such cabinets. Excessive bending or twisting of the fiber optic cable can cause damage to the hair-thin fibers inside the optic cable and attenuation of the optical signal in the fiber.

In addition, electronic circuitry is often operationally degraded by electromagnetic interference, hereinafter referred to as EMI. The lack of adequate shielding may allow EMI from an external source to affect such electronic circuitry and may allow this circuitry to contaminate the surrounding area with EMI.

It is therefore desirable to provide a receptacle that easily and securely receives a fiber optic coupler containing a fiber optic cable that limits the bend radius of the cable once it has been connected to the coupler in the receptacle. Furthermore, it is desirable to attenuate external EMI penetrating the receptacle, and thus, reduce the magnitude of the EMI energy which couples to and degrades the electronic circuitry.

### SUMMARY OF THE INVENTION

The invention provides a receptacle for a plurality of optical connectors. The receptacle may be a receiving housing having a plurality of surfaces for mounting the housing to a receiving member having first and second faces. The connector receiving housing has a cavity therein and one or more passages adjacent to the cavity for receiving the optic cable connectors. A protrusion on the connector receiving housing engages the first face of the receiving member; and a lip on the connector receiving housing engages the second face of the receiving member. The housing is mounted to the receiving member by the interaction of the lip and the protrusion.

It is one aspect of this invention to provide a receptacle for a fiber optic cable connector having a plurality of optical fibers. The receptacle comprising a polycarbonate connector receiving housing having a cavity therein for receiving the fiber optic cable connector and one or more passages through the cavity. The housing having a plurality of surfaces including front, right side and left side, the plurality of surfaces and the cavity being coated with a conductive material. The housing also having a protrusion on each of the right and left side surfaces, each protrusion ending with an edge, the protrusion permits the housing to slide through the receiving member and a lip around the front side surface of the housing, whereby the housing is secured into the opening in the receiving member by the interaction of the lip around the front side surface and the edge on the protrusion.

In accordance with another aspect of this invention, it is further desirable to provide an electrical component assembly comprising an electrical cabinet having a faceplate with first and second faces, a cable connector connected to the electrical cabinet and having a coupler with a plurality of optical fibers plugged into each side of the coupler and a polycarbonate connector receiving housing having a cavity therein for receiving the connector and one or more passages through the cavity, the housing having a plurality of surfaces coated with a conductive material. The housing having a protrusion on each of the right and left side surfaces, each protrusion defining an edge, the protrusion permits the housing to slide through the faceplate. A lip at an edge of the housing, whereby the housing is secured into the opening in the faceplate by the interaction of the lip and the edge on the protrusion.

These and other aspects of this invention are illustrated in the accompanying drawings, and are more fully disclosed in the following specification.

### BRIEF DESCRIPTION OF THE DRAWINGS

FIG. 1 is a perspective view of a prior art sheet metal receptacle in a receiving member;

FIG. 2 is a exploded perspective view of the receptacle embodying the invention and illustrating the interconnection of the receptacle self fastened into the receiving member and an accompanying fiber optic cable connector;

FIG. 3 is a perspective view of the receptacle embodying the invention;

FIG. 4 is a side view of the receptacle embodying the invention;

FIG. 4A is an exploded view of the protrusion on a side surface of the receptacle embodying the invention; and

FIG. 5 is a top view of the receptacle embodying the invention.

### DESCRIPTION OF THE INVENTION

Referring to FIG. 1, there is shown a prior art perspective view of a receptacle 100a made from sheet metal which is currently welded onto receiving member 200a, for example, an electrical cabinet faceplate. The prior art receptacle 100a also contains cutouts 101a through which EMI may pass.

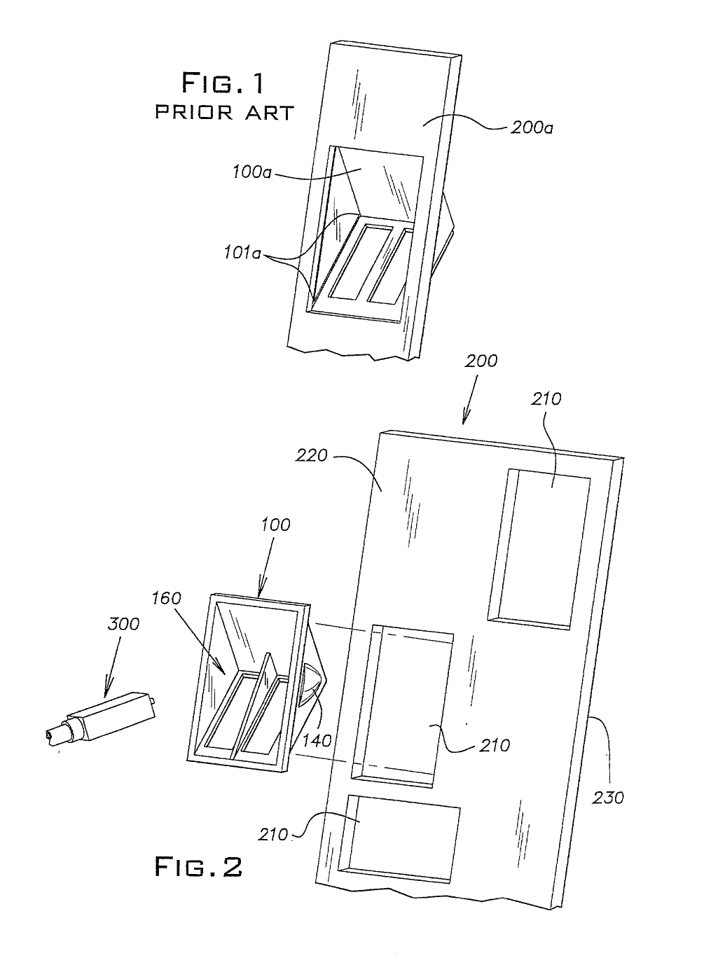

As shown in FIG. 2, the present invention provides a receptacle 100 for an optic cable connector 300. The fiber optic connector includes a fiber optic coupler (not shown) and fiber optic cables plugged into each side of the coupler. The receptacle 100 snaps into apertures 210 using protrusions 140 to lock the receptacle into place in receiving member 200, which for example, may be an electrical cabinet faceplate.

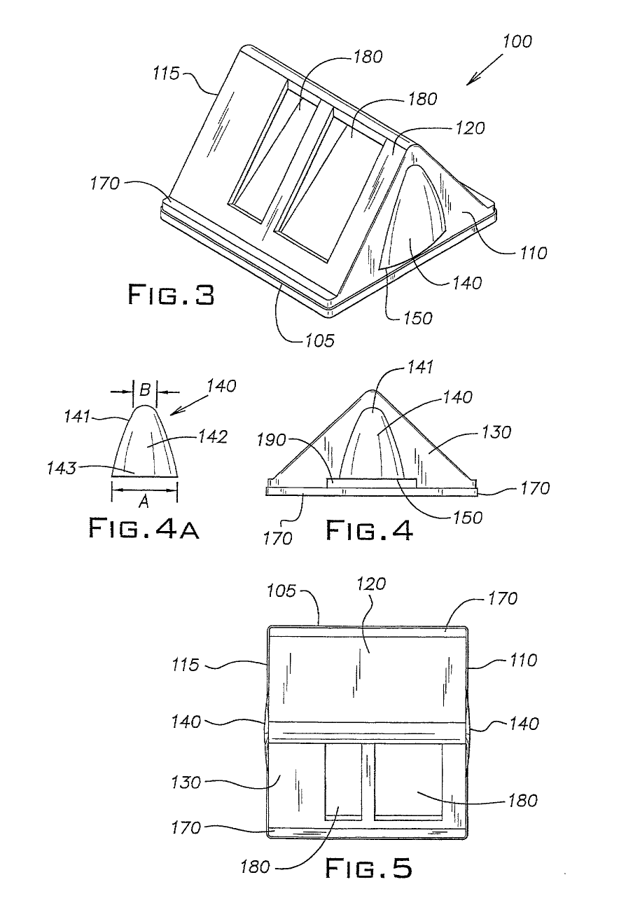

Referring to the perspective view of receptacle 100 of FIG. 3, the connector receptacle 100 includes a connector receiving housing 120 having a cavity 160 (FIG. 2) therein for receiving the optic cable connector 300. The housing 120 contains a plurality of surfaces including front surface 105, right side surface 110 and a left side surface 115.

Referring now to FIGS. 4 and 5, a protrusion 140 on each of the right and left side surfaces of the housing ends with an edge 150. The protrusion 140 permits the receptacle housing to slide through the aperture 210 in receiving member 200.

The protrusion 140 as shown in FIG. 4A, conforms substantially with less than one-half of a conical or parabolic surface containing a top portion 141, a middle portion 142 and a bottom portion 143. The protrusion on each side of the housing permits the housing to slide through a first face of the receiving member 220 (FIG. 2) and a second face of the receiving member 230. The protrusion 140 may also take on a wedge-shaped formation (not shown) that also permits the housing to slide into the receiving member.

The length of bottom portion 143, designated in FIG. 4A as A, is greater that the length of the top portion 141, designated in FIG. 4A as B. As a result of this increase in length, the lateral surface area of each portion of the protrusion also increases in total respective surface area available to that portion of the protrusion. The increase in surface area begins with the top portion 141 of protrusion 140, extends to the middle portion 142, with the greatest increase in surface area appearing at the bottom portion 143. This increase in surface area increases the spring force available to the housing upon insertion of the receptacle housing 120 into the receiving member 200. As will be described more fully hereinafter, the nature of this force will allow the housing 120 to spring outwardly into place and to lock into the receiving member 200.

Upon the insertion of the receptacle housing 120 into the receiving member 200 (FIG. 2), the sides of the housing 120 containing protrusions 140 collapse beginning at the top portion 141, then extending to the middle portion 142, and finally the collapse of the bottom portion 143. At the end of bottom portion 143 is an edge 150. When the housing 120 has been completely inserted within the receiving member 200, the bottom portion 143 will spring outwardly and will cause firm impingement of edge 150 with the first face 220 of the receiving member 200.

A lip 170 is also provided around the front side surface 105 of the receptacle housing 120. A groove 190 (FIG. 4) is located above lip 170 and below edge 150. The groove 190 extends at least the same length A, as indicated in FIG. 4A, as the length of the bottom portion 143 of protrusion 140. The presence of groove 190 in the housing 120 enables the bottom portion 143 of protrusion 140 to slide completely through the first face 220 of the receiving member 200 before engaging the second face 230 of the receiving member 200. This feature enables the housing 120 to become more effectively interlocked as a unit to receiving member 200 and for receiving the optic cable connector 300.

As shown in FIG. 5, the lip 170 is provided around the front side surface 105 of the receptacle housing 120. The receptacle housing 120 is secured into apertures 210 in the receiving member 200 by the interaction of the lip 170 around the front side surface 105 and the edge 150 on the protrusion 140 (FIG. 2).

Referring again to FIG. 2, receiving member 200 may contain a multitude of apertures 210 that are provided for snapping in place connector receptacles 100. The receiving member 200, such as an electrical cabinet faceplate, contains the first face or front face 220 and the second face or back face 230. The connector receptacle 100 snaps into place between the front face and the back face of the receiving member 200.

The connector receptacle 100 of the present invention limits the bend radius of the fiber optic cable once it has been connected to the coupler because of the 45 degree angled passage 180 inside the cavity 160. The passage 180 allows the end of the optic cable to pass through housing 120 and be electrically connected into its appropriate connection in receiving member 200.

In addition, receptacle 100 is coated with a conductive material, for example, chrome or copper-nickel, and this coating provides a substantial improvement in the attenuation of emitted EMI.

In an example embodiment, receptacle 100 is an injection molded structure formed from a polymer-based compound. The polymer-based material is a polycarbonate material flexible enough to allow the right surface 110 and the left surface 115 to curve inward when sliding the receptacle housing 120 through the receiving member 200, but also firm enough not to allow the surfaces 110, 115 to curve inwardly beyond the lip 170 on the front surface 105, once the housing is in place.

In addition, the plurality of surfaces 105,110,115 and the cavity 160 in the front surface 105 thereof for receiving an optic cable connector 300 are coated with an electrically conductive material to provide EMI shielding when the optic cable connector 300 is received within the cavity 160 of the receptacle housing.

Although the invention has been shown and described with respect to certain embodiments, it is obvious that equivalent alterations and modifications will occur to others skilled in the art upon reading and understanding of the specification. The present invention includes all such equivalent alterations and modifications, and is limited only by the scope of the claims.

What is claimed is:

1. A receptacle for a fiber optic cable connector having a plurality of optical fibers, the receptacle comprising:
a connector receiving housing having a plurality of surfaces for mounting to a receiving member having first and second faces, the connector receiving housing having a cavity therein and one or more passages adjacent the cavity for receiving the fiber optic cable connector;
a protrusion on the connector receiving housing for engaging the first face of the receiving member; and
a lip on the connector receiving housing for engaging the second face of the receiving member;
whereby the housing is mounted to the receiving member by the interaction of the lip and the protrusion.

2. The receptacle of claim 1 wherein the protrusion is wedge shaped.

3. The receptacle of claim 1 wherein the protrusion is parabolic.

4. The receptacle of claim 1 wherein the protrusion and the lip define opposed surfaces.

5. The receptacle housing of claim 1 wherein the housing is made of a polymer based material and the plurality of surfaces are coated with an electrically conductive material.

6. The receptacle housing of claim 5 wherein the conductive material is chrome.

7. The receptacle housing of claim 5 wherein the conductive material is copper-nickel.

8. The receptacle housing of claim 1 wherein the housing comprises a material that provides shielding from electromagnetic interference.

9. The receptacle housing of claim 1 wherein the passage for receiving a connector is at an angle to an opening of the cavity.

10. The receptacle housing of claim 1 wherein:
the protrusion defines an edge and permits the receptacle housing to slide through an opening in a receiving member; and whereby the housing is secured into the opening in the receiving member by the interaction of the lip and the edge on the protrusion.

11. The receptacle housing of claim 5 wherein the polymer based material is a polycarbonate material.

12. A receptacle for a fiber optic cable connector having a plurality of optical fibers, the receptacle comprising:
a connector receiving housing made of a polymer based material having a cavity therein for receiving the fiber optic cable connector and one or more passages through the cavity, the housing having a plurality of surfaces including front, right side and left side, the plurality of surfaces and the cavity being coated with a conductive material;
the housing having a protrusion on each of the right and left side surfaces, each protrusion ending with an edge, the protrusion permits the housing to slide through the receiving member; and
a lip around the front side surface of the housing;
whereby the housing is secured into the opening in the receiving member by the interaction of the lip around the front side surface and the edge on the protrusion.

13. The receptacle housing of claim 12 wherein the coated material is chrome.

14. The receptacle housing of claim 12 wherein the coated material is copper-nickel.

15. The receptacle housing of claim 12 wherein the passage for receiving a connector is at an angle to an opening of the cavity.

16. The receptacle housing of claim 12 wherein the housing comprises a material that provides shielding from electromagnetic interference.

17. The receptacle housing of claim 12 wherein the polymer based material is a polycarbonate material.

18. An electrical component assembly, the electronic component assembly comprising:
an electrical cabinet having a faceplate with first and second faces;
a cable connector connected to the electrical cabinet and having a plurality of optical fibers;
a connector receiving housing made of a polymer based material having a cavity therein for receiving the connector and one or more passages through the cavity, the housing having a plurality of surfaces coated with a conductive material, the housing having a protrusion on each of the right and left side surfaces, each protrusion defining an edge, the protrusion permits the housing to slide through the faceplate; and
a lip at an edge of the housing;
whereby the housing is secured into the opening in the faceplate by the interaction of the lip and the edge on the protrusion.

19. The receptacle housing of claim 18 wherein the passage for receiving a connector is at an angle to an opening of the cavity.

20. The receptacle housing of claim 18 wherein the housing comprises a material that provides shielding from electromagnetic interference.

21. The receptacle housing of claim 18 wherein the polymer based material is a polycarbonate material.
